(19) United States
(12) Patent Application Publication
(10) Pub. No.: US 2017/0262760 A1
(43) Pub. Date: Sep. 14, 2017

(54) SYSTEM AND METHOD FOR PROVIDING CONTEXTUALLY APPROPRIATE OVERLAYS

(71) Applicant: Cortica, Ltd., Tel Aviv (IL)

(72) Inventors: Igal Raichelgauz, Tel Aviv (IL); Karina Odinaev, Tel Aviv (IL); Yehoshua Y Zeevi, Haifa (IL)

(73) Assignee: Cortica, Ltd., Tel Aviv (IL)

(21) Appl. No.: 15/605,527

(22) Filed: May 25, 2017

Related U.S. Application Data
(63) Continuation-in-part of application No. 15/388,035, filed on Dec. 22, 2016.
Application No. 15/388,035 is a continuation of application No. 14/530,913, filed on Nov. 3, 2014, now Pat. No. 9,558,449.
Application No. 14/530,913 is a continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/341,637, filed on May 26, 2016.
(60) Provisional application No. 61/899,225, filed on Nov. 3, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06N 5/04; G06F 17/30; H04H 60/46; H04H 60/56; H04N 7/173; H04N 21/258; H04N 21/2668; H04N 21/466; H04N 21/81; G06Q 30/02; G06N 7/00; H04H 60/37

(52) U.S. Cl. CPC G06N 5/04; G06N 7/005; G06F 17/30017; H04H 60/46; H04H 2201/90; H04H 60/56; H04H 60/37; H04N 21/25891; H04N 21/2668; H04N 21/466; H04N 21/8106; G06F 17/30899; G06Q 30/0251; H04N 7/17318

(57) ABSTRACT

A method and system for providing contextually appropriate overlays. The method includes causing the generation of at least one signature for each of at least one input multimedia content element, wherein each signature represents a concept, wherein each concept is a collection of signatures and metadata describing the concept; correlating the concepts represented by the generated signatures to determine at least one context of the at least one input multimedia content element; determining, based on the at least one context of the at least one input multimedia content element, at least one contextually relevant reference multimedia content element, wherein each contextually relevant multimedia content element has a context matching at least one of the determined at least one context above a predetermined threshold; and causing an overlay of the at least one contextually relevant reference multimedia content element on the at least one input multimedia content element.

### CROSS-REFERENCE TO RELATED APPLICATIONS

This application claims the benefit of U.S. Provisional Application No. 62/341,637 filed on May 26, 2016. This application is also continuation-in-part (CIP) of U.S. patent application Ser. No. 15/388,035 filed on Dec. 22, 2016, now pending, which is a continuation of U.S. patent application Ser. No. 14/530,913 filed on Nov. 3, 2014, now U.S. Pat. No. 9,558,449, which claims the benefit of U.S. Provisional Application No. 61/899,225 filed on Nov. 3, 2013. The Ser. No. 14/530,913 application is also a CIP of U.S. patent application Ser. No. 13/770,603 filed on Feb. 19, 2013, now pending, which is a CIP of U.S. patent application Ser. No. 13/624,397 filed on Sep. 21, 2012, now U.S. Pat. No. 9,191,626. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414 filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to the display of multimedia content, and more specifically to a system for overlaying multimedia content that is appropriate to a current view of a user.

### BACKGROUND

Wearable computing devices are clothing and accessories incorporating advanced electronic technologies. Such wearable computing devices include head mounted devices, such as virtual reality headsets that have one or more displays configured to project an image directly in front of the eyes of a user.

Some wearable computing devices are further equipped with a network interface and a processing unit by which they are able to provide online content to the user. Wearable computing devices designed to collect and analyze signals related to user activity in order to assist in daily tasks are expected to become more and more common. Additionally, some wearable computing devices are designed to be used to provide an augmented reality experience, such that a scene that is currently in front of a user can be supplemented with additional content via the wearable computing device. However, existing solutions face challenges in providing appropriate overlays and, therefore, may result in inappropriate content and/or placement of content.

It would therefore be advantageous to provide a solution that would overcome the deficiencies of the prior art.

### SUMMARY

A summary of several example aspects of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all aspects. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a method and system for providing contextually appropriate overlays. The method comprises causing the generation of at least one signature for each of at least one input multimedia content element, wherein each signature represents a concept, wherein each concept is a collection of signatures and metadata describing the concept; correlating the concepts represented by the generated signatures to determine at least one context of the at least one input multimedia content element; determining, based on the at least one context of the at least one input multimedia content element, at least one contextually relevant reference multimedia content element, wherein each contextually relevant multimedia content element has a context matching at least one of the determined at least one context above a predetermined threshold; and causing an overlay of the at least one contextually relevant reference multimedia content element on the at least one input multimedia content element.

Certain embodiments disclosed herein also include a non-transitory computer readable medium having stored thereon instructions for causing a processing circuitry to perform a process, the process including causing the generation of at least one signature for each of at least one input multimedia content element, wherein each signature represents a concept, wherein each concept is a collection of signatures and metadata describing the concept; correlating the concepts represented by the generated signatures to determine at least one context of the at least one input multimedia content element; determining, based on the at least one context of the at least one input multimedia content element, at least one contextually relevant reference multimedia content element, wherein each contextually relevant multimedia content element has a context matching at least one of the determined at least one context above a predetermined threshold; and causing an overlay of the at least one contextually relevant reference multimedia content element on the at least one input multimedia content element.

Certain embodiments disclosed herein also include a system for providing a contextually appropriate overlay. The system comprising: a processing circuitry; and a memory, the memory containing instructions that, when executed by the processing circuitry, configure the system to: cause the generation of at least one signature for each of at least one input multimedia content element, wherein each signature represents a concept, wherein each concept is a collection of signatures and metadata describing the concept; correlate the concepts represented by the generated signatures to determine at least one context of the at least one input multimedia content element; determine, based on the at least one context of the at least one input multimedia content element, at least one contextually relevant reference multimedia content element, wherein each contextually relevant multimedia content element has a context matching at least one of the determined at least one context above a predetermined threshold; and cause an overlay of the at least one contextually relevant reference multimedia content element on the at least one input multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various embodiments disclosed herein.

FIG. 2 is a flowchart illustrating a method for providing a contextually appropriate overlay.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a flowchart illustrating a method for adding an overlay to multimedia content.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

By way of example, the various disclosed embodiments include a system and method for providing a contextually appropriate overlay. At least one input multimedia content element is obtained. In an example implementation, the at least one input multimedia content element may include, e.g., multimedia content elements captured by a wearable computing device. The at least one input multimedia content element is partitioned into a number of partitions, where each partition includes at least one object. At least one signature is generated for each partition. The signatures are analyzed to identify at least one partition as a target area of user interest. At least one context is determined for the identified at least one partition. Based on the determined at least one context, at least one contextually appropriate multimedia content element is determined. The at least one contextually appropriate multimedia content element may be overlaid on the at least one input multimedia content element. The overlaid multimedia content elements may be caused to be displayed on a user device displaying the at least one input multimedia content element. In an example implementation, the multimedia content elements may be overlaid on a display of a head mounted device.

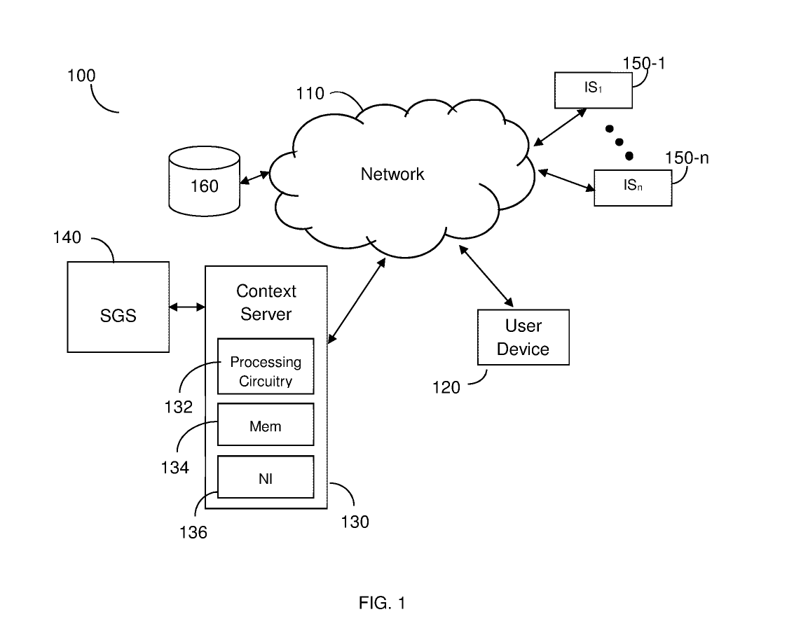

FIG. 1 shows an example schematic diagram of a network system 100 utilized to describe the various embodiments disclosed herein. A network 110 is used to communicate between different parts of the system 100. The network 110 may be the Internet, the world-wide-web (WWW), a local area network (LAN), a wide area network (WAN), a metro area network (MAN), and other networks configured to communicate between the elements of the system 100.

Further connected to the network 110 is a user device 120. In an embodiment, the user device 120 includes or is communicatively connected to at least one display and at least one source of input multimedia content elements to be displayed. Each source of input multimedia content elements to be displayed may be, but is not limited to, a sensor for capturing multimedia content elements (e.g., a camera), a virtual reality system, and the like. The user device 120 is configured to at least capture multimedia content elements showing a scene near a user wearing, holding, or otherwise in proximity to the user device 120. In an example implementation, the user device 120 may be a head mounted device configured to display augmented reality or virtual reality multimedia content.

Additionally, connected to the network 110 is a plurality of data sources 150-1 through 150-n (collectively referred to hereinafter as data sources 150 or individually as a data source 150, merely for simplicity purposes). Each of the data sources 150 may be, for example, a web server, an application server, a publisher server, an ad-serving system, a data repository, a database, and the like. Also connected to the network 110 is a data warehouse 160 that stores multimedia content elements and clusters of multimedia content elements. In the embodiment illustrated in FIG. 1, an overlay provider 130 communicates with the data warehouse 160 through the network 110. In other non-limiting configurations, the overlay provider 130 is directly connected to the data warehouse 160.

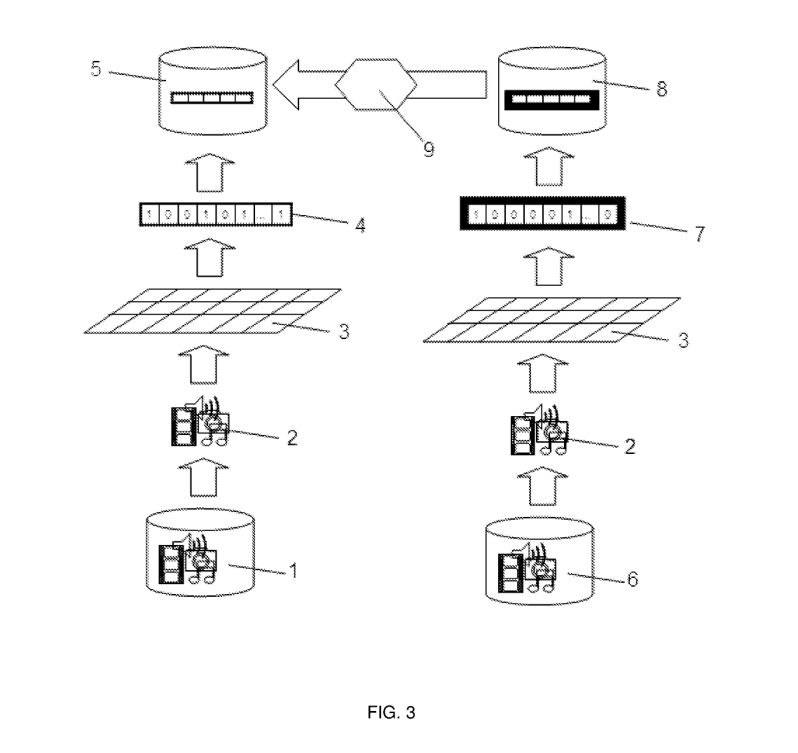

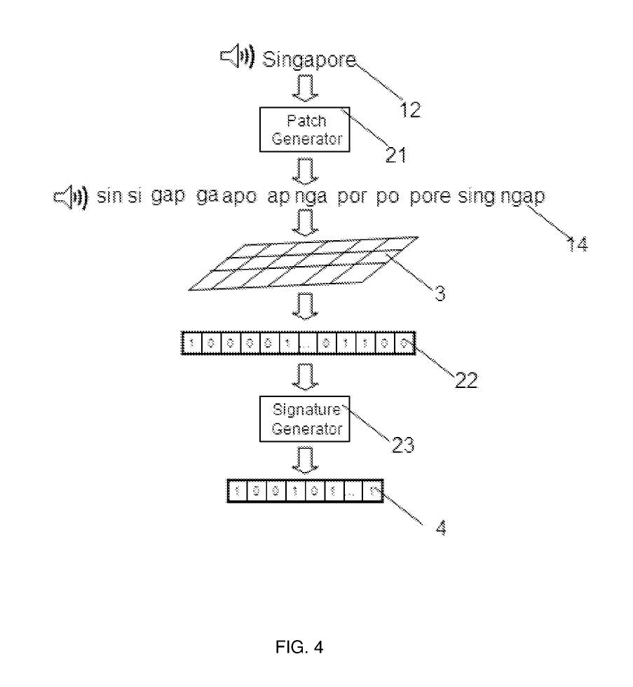

The various embodiments disclosed herein are realized using the overlay provider 130 and a signature generator system (SGS) 140. The SGS 140 may be connected to the overlay provider 130 directly or through the network 110. In an embodiment, the overlay provider 130 is configured to send multimedia content elements to the SGS 140, and to cause the SGS 140 to generate a signature for the multimedia content elements. In another embodiment, the overlay provider 130 may include the SGS 140 or otherwise be configured to generate signatures for multimedia content elements as described further herein. The process for generating the signatures for multimedia content is explained in more details herein below with respect to FIGS. 3 and 4.

It should be noted that the overlay provider 130 typically comprises a processing circuitry 132 that is coupled to a memory 134, and optionally a network interface 136. The memory typically contains instructions that can be executed by the processing circuitry. In an embodiment, the processing circuitry 132 is realized as or includes an array of computational cores configured as discussed in more detail herein below. In another embodiment, the processing circuitry 132 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The overlay provider 130 is configured to access input multimedia content elements from the user device 120 and reference multimedia content elements from the data sources 150. The overlay provider 130 is further configured to analyze the multimedia content elements to determine the context of the multimedia content elements. In an embodiment, the analysis is based on at least one signature generated for each multimedia content element. It should be noted that the context of an individual multimedia content element or a group of elements can be generated directly or retrieved from the data warehouse 160.

In a non-limiting example, a user can operate the user device 120, such as by placing a head mounted device over the user's eyes. As the user directs the device toward various scenes, a camera within the head mounted device capture video of the current scene. The captured video is sent to the overlay provider 130. The input multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof.

In an embodiment, the overlay provider 130 is configured to analyze the input multimedia content elements to determine at least one context for the at least one input multimedia content element. For example, if the input multimedia content elements include images of palm trees, a beach, and the coast line of San Diego, the context of the images may be determined to be “California sea shore.”

In an embodiment, the context may be further determined based on at least one interest of a user of the user device 120. To this end, in a further embodiment, the overlay provider 130 may be configured to correlate signatures representing at least one user interest with the signatures of the input multimedia content elements to determine the at least one context for the at least one input multimedia content element.

The input multimedia content element can be split into partitions that each contain an object or subject of interest to the user. According to the disclosed embodiments, the received input multimedia content elements are partitioned by the overlay provider 130 to a plurality of partitions. At least one of these partitions is identified as the target area of user interest based on the context of the multimedia content element. In an embodiment, metadata related to the user of the user device 120 may be further be analyzed in order to identify the target area of user interest. This metadata may include, for example, user demographics, user preferences and user history. To this end, the SGS 140 is configured to generate at least one signature for each input multimedia content element provided by the overlay provider 130. The generated signature(s) may be robust to noise and distortions as discussed below.

Using the generated signature(s), the overlay provider 130 is configured to determine the context of the elements and retrieve a contextually relevant reference multimedia content element to overlay on the user device display. The reference multimedia content elements may be obtained from at least one of the data sources 150, the data warehouse 160, locally on the user device 120, or a combination thereof. The reference multimedia content elements are analyzed by the overlay provider 130 and the signature generator 140 to determine if a reference multimedia content element is contextually appropriate to be displayed on the user device 120. In an embodiment, a reference multimedia content element may be contextually appropriate to at least a portion of an input multimedia content element (e.g., one or more partitions of the input multimedia content element) if a context of the reference multimedia content element matches the determined context of the portion of the input multimedia content element.

In a non-limiting example, a user wears a head mounted device while walking down a city street that includes a row of various restaurants. The head mounted device includes a camera that captures video of the city street as the user walks down the street, and images showing the restaurants is sent to the context server. Based on correlation of signatures generated for the image and signatures representing a user interest of “vegan”, a context of “vegan restaurant” is determined. A reference image of a menu of the restaurant may be associated with the context “vegan restaurant” and, accordingly, may be determined as relevant. The menu image is retrieved from a data source, e.g., a server hosting the restaurant's website, and overlaid on a display of the head mounted device, allowing a user to see, in real time, a menu placed adjacent to or on top of a live image of the restaurant.

It should be noted that using signatures for determining the context ensures more accurate reorganization of multimedia content than, for example, when using metadata. For instance, in order to provide a matching multimedia content element related to a sports car it may be desirable to locate a particular model of a car. However, in most cases the model of the car would not be part of the metadata associated with the multimedia content (image). Moreover, the car shown in an image may be at angles different from the angles of a specific photograph of the car that is available as a search item. This is especially true of images captured from wearable user devices 120. The signature generated for that image, however, would enable accurate recognition of the model of the car because the signatures generated for the multimedia content elements, according to the disclosed embodiments, allow for recognition and classification of multimedia content elements, such as, content-tracking, video filtering, multimedia taxonomy generation, video fingerprinting, speech-to-text, audio classification, element recognition, video/image search and any other application requiring content-based signatures generation and matching for large content volumes such as web and other large-scale databases.

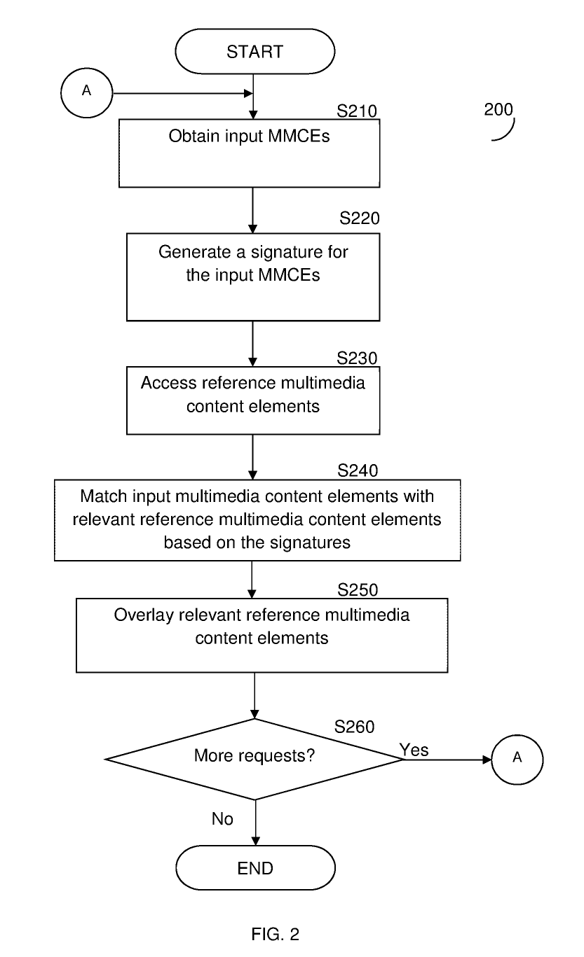

FIG. 2 depicts an example flowchart 200 illustrating a method for providing contextually appropriate overlays according to an embodiment. The execution of the method may be triggered when an input multimedia content element is captured with a user device.

At S210, at least one input multimedia content element is obtained. In an example implementation, the input multimedia content elements may be received from at least one source of input multimedia content elements to be displayed such as, but not limited to, at least one camera, a virtual reality system, and the like.

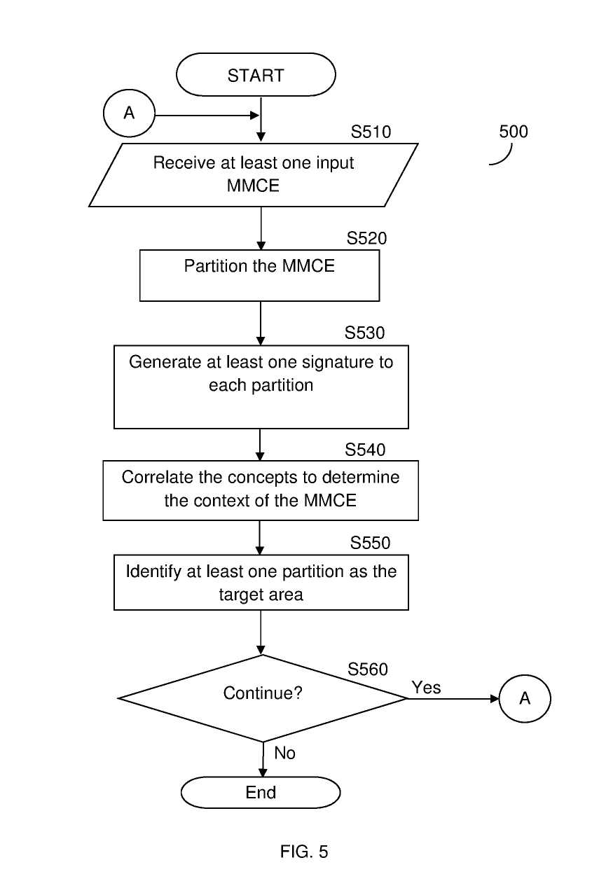

At S220, at least one signature is generated for the at least one input multimedia content element. The signature for the input multimedia content element is generated by a signature generator system as described herein below with respect to FIGS. 3 and 4. In an embodiment, the input multimedia content elements may each be partitioned into a plurality of partitions and at least one signature is generated for each partition. In a further embodiment, based on the generated signatures, at least one partition of the input multimedia content element is determined to be a target area of a user interest, as described herein below with respect to FIG. 5.

At S230, a plurality of reference multimedia content elements is accessed. The reference multimedia content elements can be stored in a data warehouse (e.g., the data warehouse 160 in FIG. 1) or may be stored in at least one data source (e.g., the data source 150 in FIG. 1), such as a server of a website or a publicly available cloud service. Each reference multimedia content element is assigned a signature, which can be generated by a signature generator, as described herein. Alternatively, a list of pre-generated signatures for the reference multimedia content elements may be stored and accessible, such as from a data warehouse.

At S240, the signatures of the input multimedia content elements are matched with the signatures of the reference multimedia content elements. The signatures generated for the reference multimedia content elements may be clustered and the cluster of signatures is matched to the signature of the input multimedia content elements. The matching of signatures can be performed by the computational cores that are part of a large-scale matching discussed in detail below.

At S250, at least one relevant reference multimedia content element is overlaid on the at least one input multimedia content element. In an embodiment, S250 includes determining a context for each portion of the at least one input multimedia content element (e.g., for each partition) and comparing the determined contexts to contexts associated with a plurality of reference multimedia content elements to determine at least one contextually relevant reference multimedia content element. In a further embodiment, the context of each input multimedia content element portion may be determined based on correlations among concepts represented by signatures of the input multimedia content elements. In yet a further embodiment, the context is determined further based on correlations with signatures representing at least one user interest. In another embodiment, S250 may include retrieving the relevant reference multimedia content elements to be overlaid, and overlaying each relevant reference multimedia content element with respect to the corresponding portion of the at least one input multimedia content element.

At S260, it is determined if additional input multimedia content elements are received for analysis. If so, the process repeats from S210; otherwise, the process terminates.

FIGS. 3 and 4 illustrate the generation of signatures for the multimedia content elements by the SGS 140 according to an embodiment. An example high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An example process of signature generation for an audio component is shown in detail in FIG. 4. Finally, Target Robust Signatures and/or Signatures are effectively matched, by a matching algorithm 9, to a Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the overlay provider 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci ={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)^{l}<<1

i.e. given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})≈l/L

approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A computational core generation is a process of definition, selection, and tuning of the parameters of the cores for a certain realization in a specific system and application. The process is based on several design considerations, such as:
(a) The cores should be designed so as to obtain maximal independence, i.e., the projection from a signal space should generate a maximal pair-wise distance between any two cores' projections into a high-dimensional space.
(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The cores should be optimally designed with regard to invariance to a set of signal distortions, of interest in relevant applications.

A detailed description of the computational core generation and the process for configuring such cores is discussed in more detail in U.S. Pat. No. 8,655,801 referenced above.

FIG. 5 depicts an example flowchart 500 illustrating a method for identifying a target area of user interest in an input multimedia content element according to an embodiment. A target area is considered a partition of a multimedia content element containing an object of interest to the user.

At S510, at least one multimedia content element is obtained. The obtained at least one multimedia content element can be captured by a user device, or displayed on the user device, and may be received from the user device, retrieved (e.g., from a local storage of the user device, from at least one data source, etc.), or both. For example, the multimedia content element can be an image captured by a camera on a head mounted device worn by a user.

At S520, the at least one input multimedia content element is partitioned to a plurality of partitions. Each partition includes at least one object. Such an object can be displayed or played on the user device. For example, an object may be a portion of a video clip which can be captured or displayed on a head mounted device.

At S530, at least one signature is generated for each partition of the multimedia content element. As noted above, each generated signature represents a concept. The signature generation is further described hereinabove with respect to FIGS. 3 and 4. In an embodiment, a concept that matches the signatures can be retrieved from the data warehouse 160. Techniques for retrieving concepts matching to signatures are further discussed in U.S. Pat. No. 8,266,185, assigned to the common assignee, which is hereby incorporated by reference.

At S540, at least one context of the multimedia content element is determined. As noted above, this can be performed by correlating the concepts.

At S550, based on the determined at least one context, at least one partition of the multimedia content is identified as the target area of user interest. In an embodiment, the signature generated for each partition is compared against the determined context. The partition of the signature that best matches the context may be determined as the best match. Alternatively or collectively, metadata related to the user of the user device may further be analyzed in order to identify the target area of user interest. Such metadata may include, for example, personal variables related to the user, such as: demographic information, the user's profile, experience, a combination thereof, and so on. In an embodiment, at least one personal variable related to a user is received and a correlation above a predetermined threshold between the at least one personal variable and the at least one signature is found.

At S560, it is checked whether an additional input multimedia content element has been received and, if so, execution continues with S520; otherwise, execution terminates. It should be noted that a new input multimedia content element may refer to an input multimedia element previously viewed, but a different portion of such element is currently being viewed by the user device than was previously viewed.

As a non-limiting example, an image of several basketball players is captured by a camera of a wearable computing device. The captured image is partitioned to a number of partitions, where each partition features one player, and a signature is generated for each partition. Each signature represents a concept and by correlating the concepts; the context of the image is determined as the Los Angeles Lakers® basketball team. The user's experience indicates that the user has conducted several searches for the Los Angeles Lakers® basketball player Kobe Bryant. Based on correlations among signatures for the Los Angeles Lakers® and a user interest in Kobe Bryant, a context of “Kobe Bryant” is determined. Respective thereto, the area in which Kobe Bryant is shown is identified as the target area of user interest.

It should be noted that various embodiments are described herein with respect to a head mounted device including a camera merely for example purposes and without limitation on the disclosed embodiments. The disclosed embodiments may be equally utilized to overlay contextually relevant multimedia content elements on other displays without departing from the scope of the disclosure. Further, various disclosed embodiments are discussed with respect to overlaying contextually appropriate multimedia content elements on a display of a scene in front of a user (e.g., for augmented reality) merely for example purposes and without limiting the disclosed embodiments. The disclosed embodiments may be equally utilized with respect to providing overlays for displays of, for example but not limited to, virtual reality environments without departing from the scope of the disclosure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing contextually appropriate overlays, comprising:
causing generation of at least one signature for each of at least one input multimedia content element, wherein each signature represents a concept, wherein each concept is a collection of signatures and metadata describing the concept;
correlating the concepts represented by the generated signatures to determine at least one context of the at least one input multimedia content element;
determining, based on the at least one context of the at least one input multimedia content element, at least one contextually relevant reference multimedia content element, wherein each contextually relevant multimedia content element has a context matching at least one of the determined at least one context above a predetermined threshold; and
causing an overlay of the at least one contextually relevant reference multimedia content element on the at least one input multimedia content element.

2. The method of claim 1, further comprising:
receiving, from a wearable computing device, the at least one input multimedia content element.

3. The method of claim 1, further comprising:
identifying, based on the generated at least one signature, at least one a target area of user interest.

4. The method of claim 3, further comprising:
wherein the at least one target area of user interest is identified based on the context.

5. The method of claim 4, wherein the generated at least one signature further includes at least one signature representing at least one user interest.

6. The method of claim 3, wherein each relevant reference multimedia content element is overlaid on one of the at least one target area of user interest.

7. The method of claim 1, further comprising:
partitioning the at least one input multimedia content element into a plurality of partitions, wherein each of the plurality of partitions includes at least one object, wherein each concept represented by a signature generated for one of the plurality of partitions corresponds to one of the at least one object of the partition.

8. The method of claim 1, wherein each signature is robust to noise and distortions.

9. The method of claim 1, wherein the at least one contextually relevant multimedia content element is overlaid on a display of a head mounted device including at least one camera, wherein the at least one input multimedia content element is captured by the at least one camera.

10. A non-transitory computer readable medium having stored thereon instructions for causing a processing circuitry to perform a process, the process comprising:
causing generation of at least one signature for each of at least one input multimedia content element, wherein each signature represents a concept, wherein each concept is a collection of signatures and metadata describing the concept;
correlating the concepts represented by the generated signatures to determine at least one context of the at least one input multimedia content element;
determining, based on the at least one context of the at least one input multimedia content element, at least one contextually relevant reference multimedia content element, wherein each contextually relevant multimedia content element has a context matching at least one of the determined at least one context above a predetermined threshold; and
causing an overlay of the at least one contextually relevant reference multimedia content element on the at least one input multimedia content element.

11. A system for overlaying content on a multimedia content element, comprising:
a processing circuitry; and
a memory, the memory containing instructions that, when executed by the processing circuitry, configure the system to:
cause the generation of at least one signature for each of at least one input multimedia content element, wherein each signature represents a concept, wherein each concept is a collection of signatures and metadata describing the concept;
correlate the concepts represented by the generated signatures to determine at least one context of the at least one input multimedia content element;
determine, based on the at least one context of the at least one input multimedia content element, at least one contextually relevant reference multimedia content element, wherein each contextually relevant multimedia content element has a context matching at least one of the determined at least one context above a predetermined threshold; and
cause an overlay of the at least one contextually relevant reference multimedia content element on the at least one input multimedia content element.

12. The system of claim 11, further comprising:
receive, from a wearable computing device, the at least one input multimedia content element.

13. The system of claim 11, further comprising:
identify, based on the generated at least one signature, at least one a target area of user interest.

14. The system of claim 13, further comprising:
wherein the at least one target area of user interest is identified based on the context.

15. The system of claim 14, wherein the generated at least one signature further includes at least one signature representing at least one user interest.

16. The system of claim 13, wherein each relevant reference multimedia content element is overlaid on one of the at least one target area of user interest.

17. The system of claim 11, further comprising:
partition the at least one input multimedia content element into a plurality of partitions, wherein each of the plurality of partitions includes at least one object, wherein each concept represented by a signature generated for one of the plurality of partitions corresponds to one of the at least one object of the partition.

18. The system of claim 11, wherein each signature is robust to noise and distortions.

19. The system of claim 11, wherein the at least one contextually relevant multimedia content element is overlaid on a display of a head mounted device including at least one camera, wherein the at least one input multimedia content element is captured by the at least one camera.
